(19) United States
(12) Patent Application Publication
(10) Pub. No.: US 2026/0168416 A1
(43) Pub. Date: Jun. 18, 2026

(54) INTERNAL COMBUSTION ENGINE AND METHOD FOR OPERATING AN INTERNAL COMBUSTION ENGINE

(71) Applicant: INNIO Jenbacher GmbH & Co OG, Jenbach (AT)

(72) Inventors: Wolfgang Fimml, Maurach (AT); Clement Leroux, Fuegen (AT)

(21) Appl. No.: 19/417,307

(22) Filed: Dec. 11, 2025

(30) Foreign Application Priority Data
Dec. 12, 2024 (EP) 24219511

(51) Int. Cl. F01M 13/02; F01M 13/04; F02M 26/04; F02M 26/23; F02M 35/10

(52) U.S. Cl. CPC F01M 13/023; F01M 13/04; F02M 26/04; F02M 26/23; F02M 35/10157; F02M 35/10275; F01M 2013/0438

(57) ABSTRACT

Internal combustion engine, comprising: at least one cylinder-piston unit, a crankcase, in which the cylinder-piston unit is at least partly arranged, and a crankcase ventilation system having a discharge line, wherein the discharge line fluidically connects the crankcase to an intake system of the cylinder-piston unit, wherein the crankcase ventilation system comprises a supply line fluidically connecting the crankcase with the intake system of the internal combustion engine or the environment.

### CROSS-REFERENCE TO RELATED APPLICATION

This application claims priority to and benefit of European patent Application No. EP 24219511.3, filed on Dec. 12, 2024, entitled “INTERNAL COMBUSTION ENGINE AND METHOD FOR OPERATING AN INTERNAL COMBUSTION ENGINE”, which is herein incorporated by reference in its entirety for all purposes.

### FIELD OF THE INVENTION

The present disclosure relates to an internal combustion engine according to the preamble of claim 1 and method for operating an internal combustion engine.

### BACKGROUND

Internal combustion engines known by the state of the art comprise:
at least one cylinder-piston unit
a crankcase, in which the cylinder-piston unit is at least partly arranged, and
a crankcase ventilation system having a discharge line, wherein the discharge line fluidically connects the crankcase to an intake system of the cylinder-piston unit.

In operation of an internal combustion engine, the at least one cylinder-piston unit—forming a main combustion chamber—is provided by an air-fuel mixture during an intake stroke. Therefore, the air-fuel mixture can be supplied via the intake system to at least one cylinder-piston unit.

During a subsequent compression stroke, the air-fuel mixture is compressed by the piston in preparation for ignition.

After the power stroke—wherein the compressed air-fuel mixture is ignited and combusted—the exhaust gases generated during combustion are expelled though the exhaust system from the cylinder-piston unit and the process begins once more with the intake stroke.

Internal combustion engines designed to be operated according to this method are also known as four-stroke engines.

During the compression stroke, the piston is moved inside the cylinder to decrease the volume of the air-fuel-mixture for compression of the air-fuel-mixture, wherein the size or volume of the main combustion chamber is reduced.

The piston is therefore sealed with respect to an inner surface of a cylinder to prevent a leakage of the air-fuel mixture from the main combustion chamber and allow an effective compression.

For sealing between the piston and the inner wall of the cylinder, it is commonly known to use piston rings.

But in fact, it is also known, that such a sealing of the piston is never 100 per cent leak-proof, wherein a small amount of air-fuel mixture passes through leaks between the piston and the cylinder into the crankcase of the internal combustion engine.

This amount of air-fuel mixture passing into the crankcase is in almost all cases so small that it does not noticeably affect the combustion process.

But—especially in stationary internal combustion engines having a high piston displacement—a risk is present that this air-fuel mixture present in the crankcase is ignited or combusted, wherein severe damage of the internal combustion engine can occur and there is a large risk of injury for an operator standing near the internal combustion engine.

Therefore, it is known in the state of the art to remove such ignitable and combustible gases and gas-mixtures from the crankcase using crankcase ventilation systems, wherein the crankcase is simply ventilated by air.

Such systems have been used very effectively with internal combustion engines combusting common fuels, such as natural gas, methane, or propane.

Nowadays, internal combustion engines routinely also have to be able to deal with carbon dioxide neutral fuels, such as, e.g., molecular hydrogen. The use of hydrogen and carbon dioxide neutral fuels has become more and more important to reduce emissions and to improve the environmental aspect of an internal combustion engine.

As such fuels may comprise a much higher inflammability and ignitability, crankcases have to be ventilated much more intensely, wherein in some cases even an active ventilation using fans has to be provided to minimize the risk of an ignition or combustion of an air-fuel mixture inside the crankcase.

Such intricate ventilation systems require a large effort for production and lots of energy to operate, wherein the overall efficiency of the internal combustion engine is reduced and the efforts to provide such a system are high.

### BRIEF DESCRIPTION

The object of the present disclosure is therefore to provide an internal combustion engine as well as a method for operating an internal combustion engine which at least partly improves upon the mentioned negative effects compared to the prior art and/or reduces the risks of combustions inside a crankcase and/or improves the overall efficiency and economic aspect of an internal combustion engines having a crankcase ventilation systems and/or reduce efforts which are related with crankcase ventilation systems, in particular to provide a simpler crankcase ventilation system.

This object is achieved with an internal combustion engine with the features set forth in the claims as well as a method for operating an internal combustion engine with the features set forth in the claims.

According to the present disclosure, an internal combustion engine is provided, comprising:
at least one cylinder-piston unit
a crankcase, in which the cylinder-piston unit is at least partly arranged, and
a crankcase ventilation system having a discharge line, wherein the discharge line fluidically connects the crankcase to an intake system of the cylinder-piston unit, preferably wherein the discharged gas of the crankcase is at least partially supplied via the intake system into the at least one cylinder-piston unit,
wherein the crankcase ventilation system comprises a supply line fluidically connecting the crankcase with the intake system of the internal combustion engine or the environment.

In one highly preferred embodiment, it can be provided that by use of at least a partial mass or gas flow branched from the intake system and fed into the crankcase, a gas flow through the crankcase for ventilation of the crankcase can be supported.

In other embodiments, it can be provided that by use of the discharge line—which line fluidically connects the crankcase to an intake system—an already existing mass or gas flow can be used to support a gas flow through the crankcase, wherein by use of the discharge line and the intake system gas from the environment can be sucked through the crankcase for ventilation.

In both cases, the crankcase ventilation system is able to support a mass or gas flow through the crankcase, wherein the flammability and/or ignitability of gases or gas-mixtures in the crankcase can be decreased, as the oxygen concentration can be increased massively in the crankcase.

Therefore, instead of actively flushing of the crankcase with a large amount of air to dilute the air-fuel mixture inside the crankcase by using additional ventilation systems, an already existing mass or gas flow can be used to inhibit the flammability or ignitibility of an air-fuel mixture inside the crankcase more effectively.

In fact, active ventilation systems such as fans are not necessary any more. However, it should be noted that fans for ventilating the crank case can in some very special embodiments of the present disclosure still be present.

Therefore, the presently disclosed embodiments provide a way to use already present resources of the internal combustion engine to reduces the risks of combustions inside a crankcase.

Thereby, the overall efficiency and economic aspect of internal combustion engines can be improved.

Also, the efforts which are related to provide an internal combustion engine with a crankcase ventilation system can be reduced.

It should be mentioned that the present disclosure is not limited to four-stroke engines. However, in preferred embodiments of the disclosure, the internal combustion engine is a four-stroke engine.

In preferred embodiments the internal combustion engine is configured to combust molecular hydrogen, natural gas, methane, and/or propane as fuel.

Already present internal combustion engines can be upgraded with at least one crankcase ventilation system according to certain embodiments of the invention.

Already present internal combustion engines can be upgraded and operated with a cylinder head arrangement according to the present disclosure. Therefore, the present disclosure can be used for the embodiments of the prior art already described in the introduction of the description.

The present disclosure can particularly preferably be used in conjunction with an internal combustion engine driving a generator for creating electrical energy. Such combinations of internal combustion engines driving a generator are known as gensets.

The internal combustion engine or genset can preferably be stationary or for naval use.

The expressions “downstream” or “upstream” present in this document can be understood as expressions in relation to a material flow during operation of the internal combustion engine, e.g., downstream in the exhaust system has to be understood as a point in the exhaust system being passed by the exhaust gas at a later moment in time during operation of the internal combustion engine.

Advantageous embodiments of the invention are defined in the dependent claims.

It can be provided that the supply line comprises at least one throttle valve.

The intake system can be provided by at least one compressor, preferably wherein the at least one compressor is part of a turbocharger being mechanically coupled to an exhaust turbine arranged in an exhaust system.

It can be provided that the discharge line is fluidically coupled with the intake system upstream of the compressor.

It can be provided that the supply line is fluidically coupled with the intake system downstream of the compressor.

The discharge line can be provided by at least one blow-by filter for separating particles, droplets, fuel vapor and/or other gases from the discharged gas of the crankcase.

The intake system can be provided by at least one heat exchanger, preferably at least one intercooler, wherein the supply line of the crankcase ventilation system branches off the intake system, downstream of the at least one heat exchanger.

It can be provided that an exhaust system comprises at least one exhaust turbine, preferably wherein the at least one exhaust turbine is part of a turbocharger being mechanically coupled to a compressor arranged at the intake system.

The internal combustion engine can be provided by an exhaust gas recirculation system, wherein an exhaust gas recirculation duct is fluidically connected to an exhaust system and the intake system and is provided to branch off at least a part of the exhaust gas of the exhaust system and feed this exhaust gas into the intake system.

It can be provided that the exhaust system—preferably the exhaust gas recirculation system—comprises at least one heat exchanger for cooling the exhaust gas.

The internal combustion engine can be provided by a stationary reciprocating gas engine operated by hydrogen and/or hydrocarbons, preferably driving a mechanically coupled generator for providing electrical energy to a power grid.

Furthermore, protection is sought for a method for operating an internal combustion engine, preferably an internal combustion engine according to the present disclosure, comprising combusting in at least one cylinder-piston unit of the internal combustion engine an air-fuel—mixture preferably comprising hydrogen—wherein by using a discharge line fluidically coupled to the intake system to feed a gas from the environment or the intake system through the crankcase into the intake system.

It can be provided that the method further comprises supplying the gas into the crankcase via a supply line branching of an intake system of the internal combustion engine.

### BRIEF DESCRIPTION OF THE DRAWINGS

Further details and advantages of the invention are apparent from the accompanying figures and the following description of the figures. The figures show:

FIG. 1 illustrates a first embodiment of an internal combustion engine according to the present disclosure, and

FIG. 2 illustrates a second embodiment of an internal combustion engine according to the present disclosure.

### DETAILED DESCRIPTION

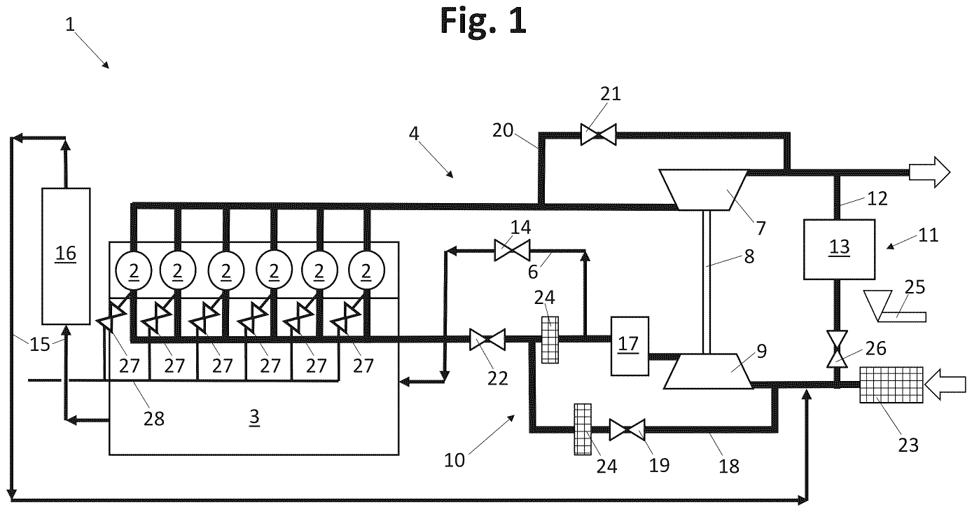

FIG. 1 illustrates a first embodiment of an internal combustion engine 1 according to the present disclosure.

This internal combustion engine 1 comprises six cylinder-piston units 2 providing combustion chambers in which an air-fuel mixture is combusted.

Embodiments of the invention are, of course, not restricted to a single or six cylinder-piston units 2 used in the Figures serves only as an example. Embodiments of the invention can be used on an internal combustion engine 1 for one or more cylinder-piston units 2.

The air-fuel mixture supplied to the combustion chambers of the cylinder-piston units 2 is mixed inside the intake ports of each of the cylinder-piston units 2.

By use of the port-injection valves 27, fuel (in this embodiment hydrogen) of the fuel supply grid 28 can be injected into the intake ports, wherein inside the intake ports (and inside the combustion chambers) the fuel is mixed with air supplied via the intake system 10.

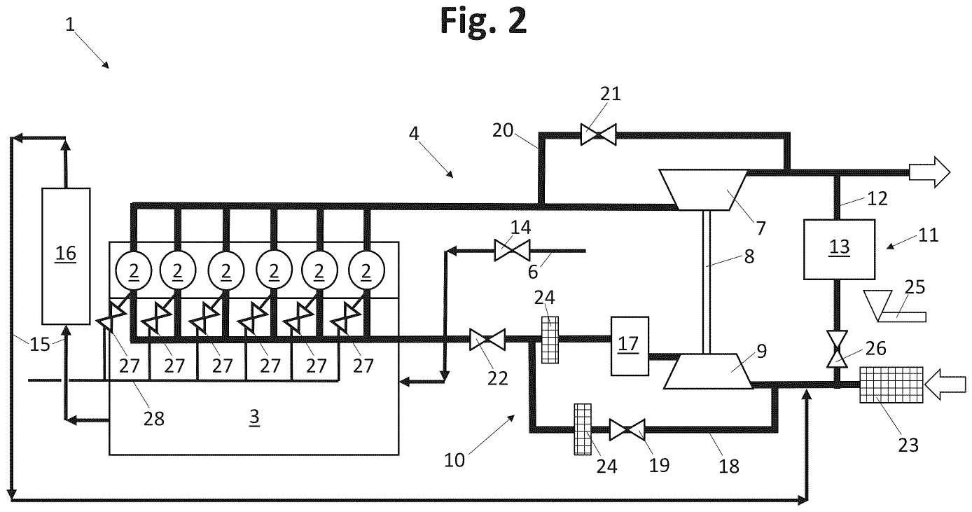

Additionally or alternatively, it can be provided that air-fuel mixture supplied to the combustion chambers of the cylinder-piston units 2 is mixed by a gas mixer (not illustrated in FIGS. 1 and 2) upstream of the compressor 9, wherein a fuel or a fuel mixture—e.g., provided by a fuel supply grid 28—can be mixed with air and passed to the compressor 9.

Alternatively, it can also be provided that the air-fuel mixture is provided in the cylinder-piston units 2 by mixing a separately supplied fuel—e.g., a fuel supplied by a port injection valve 27 directly into the cylinder-piston units 2—and an air supplied via the intake system 10 inside the combustion chambers (wherein the combustion chambers are provided by the cylinder-piston units 2).

In this specific embodiment of FIG. 1, the air for forming the air-fuel mixture is supplied via the intake system 10 and the fuel—preferably hydrogen—is supplied via port injection valves 27 provided for each cylinder-piston unit 2.

The air is supplied to the cylinder-piston units 2 through a compressor 9 of a turbocharger 8, wherein the air can be cooled after compression by the compressor 9 in an intercooler 17.

The air compressed by the compressor 9 is supplied via the air filter 23 from the environment of the internal combustion engine 1.

The compressor 9 of the turbocharger 8 is driven by a mechanically connected exhaust turbine 7, which is arranged in the exhaust system 4 and driven by exhaust gases resulting from the combustion inside the piston-cylinder units 2.

The intercooler 17 and the compressor 11 can be bypassed by means of an intake bypass line 18 with a compressor bypass valve 19, wherein a boost pressure can be adjusted by this compressor bypass valve 19 and with that boost pressure the piston-cylinder units 2 can be filled.

By changing the boost pressure, it is possible to vary the filling of piston-cylinder units 2.

Furthermore, the intake system 10 comprises a throttle valve 22, wherein an air mass supplied to the piston-cylinder units 2 can be controlled by the opening degree of the throttle valve 22.

To avoid back fires inside the intake system 10 flame arrestors 24 are provided.

An exhaust system 4 for discharging an exhaust gas from the cylinder-piston units 2 after combustion is provided being connected to each cylinder-piston unit 2.

In addition, the turbocharger 8 has an exhaust turbine 7 being arranged at the exhaust system 4.

The turbocharger 8 can be bypassed by an exhaust bypass line 20 along with the turbine bypass valve 21.

By means of this turbine bypass valve 21, an exhaust backpressure can be set which acts on the combustion chambers of the piston-cylinder units 2.

Furthermore, the internal combustion engine 1 comprises an exhaust gas recirculation system 11, wherein an exhaust gas recirculation duct 12 is fluidically connected to the exhaust system 4 and the intake system 10 and is provided to branch off a part of the exhaust gas of the exhaust system 4 and feed this exhaust gas into the intake system 10.

The exhaust gas recirculation duct 12 branches off the downstream of the exhaust turbine 7 and the exhaust bypass line 20 of the exhaust system 4.

The exhaust gas recirculation system 11 comprises a heat exchanger 13 for cooling the exhaust gas.

Furthermore, the heat exchanger 13 is provided by a condensate separator 25, wherein condensate buildup during cooling down the exhaust gas by the heat exchanger 13 can be led out from the system.

By use of the exhaust gas recirculation valve 26, a mass of exhaust gas passed into the intake system 10 can be controlled and therefore an exhaust gas recirculation rate can be adjusted.

The piston of the piston-cylinder units 2 is mechanically connected via connecting rods with a crankshaft (for reasons of clarity not shown), wherein the crankshaft is rotatably arranged inside the crankcase 3.

For ventilation of the crankcase 3—to evacuate air-fuel-mixture passed into the crankcase 3—a crankcase ventilation system 5 is provided.

The crankcase ventilation system 5 comprises a supply line 6 which is fluidically coupled to the intake system 10, such that gas—in this case compressed air—is passed from the intake system 6 via the supply line 6 of the crankcase ventilation system 5 into the crankcase 3 of the internal combustion system 1.

In particular, the supply line 6 of the crankcase ventilation system 5 branches off the intake system downstream the compressor 9 and the intercooler 27 and upstream of the flame attestor 24.

The supply line 6 of the crankcase ventilation system 5 comprises at least one mass and/or volume flow control device, namely a throttle valve 14, for controlling a mass and/or volume flow of gas into and/or though the crankcase 3.

After passing the crankcase 3, the discharged gas—carrying particles, droplets, fuel vapor and/or other gases—can be discharged from the crankcase 3 via a discharge line 15.

The discharge line 15 is fluidically coupled to the intake system 10 upstream of the compressor 9, wherein the discharged gas of the crankcase 3 is supplied via the intake system 10 into the cylinder-piston units 2.

Furthermore, the discharge line 15 comprises a blow-by filter 16 for separating particles, droplets, and/or other gases from the discharged gas of the crankcase 3 before passing the discharged gas into the intake system 10.

FIG. 2 discloses a second embodiment of an internal combustion engine 1 according to the present disclosure, wherein in contrast to the first embodiment the supply line 6 fluidically connecting the crankcase 3 with the environment of the internal combustion engine.

In this case, a mass flow of the intake system 10 is used to provide a negative pressure at the point in which the discharge line 15 branches off the intake system 10.

By use of this negative pressure, gas of the environment of the internal combustion engine 1 is suctioned via the discharge line 15 through the crankcase 3 and the supply line 6 to ventilate the crankcase 3.

The remaining characteristics essentially correspond with the characteristics disclosed by the first embodiment shown by FIG. 1.

### LIST OF USED REFERENCE SIGNS

1 internal combustion engine
2 cylinder-piston unit
3 crankcase
4 exhaust system
5 crankcase ventilation system
6 supply line
7 exhaust turbine
8 turbocharger
9 compressor
10 intake system
11 exhaust gas recirculation system
12 exhaust gas recirculation duct
13 heat exchanger
14 throttle valve
15 discharge line
16 blow-by filter
17 intercooler
18 intake bypass line
19 compressor bypass valve
20 exhaust bypass line
21 turbine bypass valve
22 throttle valve
23 air filter
24 flame attestor
25 condensate separator
26 exhaust gas recirculation valve
27 port-injection valve
28 Fuel supply grid

1. A system comprising:
an internal combustion engine, comprising:
at least one cylinder-piston unit;
a crankcase coupled to the at least one cylinder-piston unit; and
a crankcase ventilation system, comprising:
a discharge line fluidically connecting the crankcase to an intake system of the at least one cylinder-piston unit; and
a supply line fluidically connecting the crankcase with the intake system of the internal combustion engine or an environment.

2. The system of claim 1, wherein the supply line comprises at least one throttle valve.

3. The system of claim 1, wherein the intake system comprises at least one compressor.

4. The system of claim 3, wherein the discharge line is fluidically coupled with the intake system upstream of the at least one compressor and/or the supply line is fluidically coupled with the intake system downstream of the at least one compressor.

5. The system of claim 1, wherein the discharge line comprises at least one blow-by filter for separating particles, droplets, fuel vapor and/or other gases from a discharged gas of the crankcase.

6. The system of claim 1, wherein the intake system comprises at least one heat exchanger, wherein the supply line of the crankcase ventilation system branches off the intake system downstream of the at least one heat exchanger.

7. The system of claim 1, wherein an exhaust system comprises at least one exhaust turbine, wherein the at least one exhaust turbine is part of a turbocharger being mechanically coupled to a compressor arranged at the intake system.

8. The system of claim 1, wherein the internal combustion engine comprises an exhaust gas recirculation system, wherein an exhaust gas recirculation duct is fluidically connected to an exhaust system and the intake system and is provided to branch off at least a part of the exhaust gas of the exhaust system and feed this exhaust gas into the intake system.

9. The system of claim 8, wherein the exhaust gas recirculation system comprises at least one heat exchanger for cooling the exhaust gas.

10. The system of claim 1, wherein the internal combustion engine is a stationary reciprocating gas engine operated by hydrogen and/or hydrocarbons, driving a mechanically coupled generator for providing electrical energy to a power grid.

11. A method for operating the internal combustion engine of claim 1, comprising combusting in the at least one cylinder-piston unit of the internal combustion engine an air-fuel-mixture comprising hydrogen, and ventilating the crankcase with a gas flow from the supply line, through the crankcase, and out through the discharge line.

12. The method of claim 11, wherein ventilating the crankcase comprises supplying the gas flow into the crankcase via the supply line branching of the intake system of the internal combustion engine.

13. A system, comprising:
a crankcase ventilation system, comprising:
a discharge line configured to fluidly connect a crankcase of an internal combustion engine to an intake system of at least one cylinder-piston unit of the internal combustion engine; and
a supply line configured to fluidly connect the crankcase with the intake system of the internal combustion engine or an environment.

14. The system of claim 13, comprising the intake system having a filter, a compressor, a heat exchanger, or any combination thereof.

15. The system of claim 14, wherein the supply line is coupled to the intake system.

16. The system of claim 15, wherein the intake system comprises the filter, the compressor downstream from the filter, and the heat exchanger downstream from the compressor, wherein the supply line is coupled to the intake system downstream from the heat exchanger.

17. The system of claim 16, wherein the intake system comprises a flame arrestor downstream from the heat exchanger, and the supply line is coupled to the intake system upstream from the flame arrestor.

18. A method, comprising:
ventilating a crankcase of an internal combustion engine having at least one cylinder-piston unit, wherein ventilating comprises:
discharging a discharge flow through a discharge line from the crankcase to an intake system of the at least one cylinder-piston unit of the internal combustion engine; and
supplying a supply flow through a supply line into the crankcase from the intake system of the internal combustion engine or an environment.

19. The method of claim 18, comprising supplying the supply flow through the supply line into the crankcase from the intake system, wherein the intake system comprises a filter, a compressor, a heat exchanger, or any combination thereof.

20. The method of claim 19, wherein:
discharging the discharge flow comprises routing the discharge flow through the discharge line to the intake system upstream of a compressor; and
supplying the supply flow comprises routing the supply flow through the supply line from the intake system downstream from the compressor.
